(19) United States
(12) Patent Application Publication
(10) Pub. No.: US 2011/0157384 A1
(43) Pub. Date: Jun. 30, 2011

(54) Stabilizing rod for a video camera stabilizer

(75) Inventors: Hongbing XU, Guangdong Province (CN); Dichang ZHONG, Guangdong Province (CN); Jingxing SANG, Guangdong Province (CN)

(73) Assignee: SHENZHEN CITY MOFUKANG TECHNOLOGY CO., LTD., Guangdong Province (CN)

(21) Appl. No.: 12/650,509

(22) Filed: Dec. 30, 2009

(51) Int. Cl. H04N 5/228

(52) U.S. Cl. 348/208.99; 348/E05.031

(57) ABSTRACT

The present invention relates to a photographic apparatus and more particularly pertains to a stabilizing rod for a video camera stabilizer which comprises a data processing circuit, wherein it further comprises memory units which are connected to the data processing circuit for receiving digital format signals from the data processing circuit and recording the digital format signals. The present invention provides a stabilizing rod for a video camera stabilizer which is connected to memory units and is therefore capable of recoding image content in digital format for future editing and playback.

### BACKGROUND OF THE INVENTION

The present invention relates to a photographic apparatus and more particularly pertains to a stabilizing rod for a video camera stabilizer.

As films have irreplaceable image effect in terms of imaging, films are usually used as the recording medium for recording digital image signals during movie filming. During the filming process, real-time playback is impossible when films are used. As a result, currently when a video camera stabilizer is used for filming movies, digital image signals are transmitted to an external receiver for recording and playback via a wireless transmitting device attached on the video camera. However, such wireless transmission is easily disrupted by barriers and limited by distance and thereby affecting the stability of the signals. Besides, editing images recorded on films is not as convenient as editing images recorded in digital format.

Nowadays, many cameras and video cameras use magnetic tapes as recording medium. Magnetic tapes record data in a linear mode. Although real-time playback is possible, it takes more time to locate the frames to be played. Besides, repetitive playback adversely affects image quality.

### BRIEF SUMMARY OF THE INVENTION

The present invention provides a stabilizing rod for a video camera stabilizer which provides a function of recording digital image signals in digital format.

The stabilizing rod for a video camera stabilizer of the present invention is realized by the following technical proposal:

A stabilizing rod for a video camera stabilizer which comprises a data processing circuit, wherein it further comprises memory units which are connected to the data processing circuit to receive digital format signals from the data processing circuit and to record the digital format signals.

Further to the aforementioned main characteristics, the memory units are disposed on the stabilizing rod.

Further to the aforementioned main characteristics, the stabilizing rod for a video camera stabilizer further comprises plug-in slots which are connected to the data processing circuit for installing and removing expanded memory units.

Further to the aforementioned main characteristics, the stabilizing rod for a video camera stabilizer further comprises buttons which are connected to the data processing circuit, the memory unit, the plug-in slots and communicating ports.

Further to the aforementioned main characteristics, the stabilizing rod for a video camera stabilizer further comprises indicating lights which are connected to the data processing circuit, the memory units, the plug-in slots and the communicating ports respectively as well as to the buttons so as to indicate status of the data processing circuit, the memory units, the plug-in slots and the communicating ports.

According to the aforementioned technical proposal, the stabilizing rod for a video camera stabilizer provided by the present invention connects to memory units and is therefore capable of recording image content in digital format for future editing and playback or serving as digital backup for magnetic tapes and films. Besides, as the stabilizing rod for a video camera stabilizer connects to communicating ports, it is capable of maintaining external signal communication in digital format. As the stabilizing rod for a video camera stabilizer connects to plug-in slots, it is convenient for replacing memory units for recording large volume of content and sharing data.

### BRIEF DESCRIPTION OF THE DRAWINGS

FIG. 1 illustrates the structure of the stabilizing rod for a video camera stabilizer according to an embodiment of the present invention.

### DETAILED DESCRIPTION OF THE INVENTION

For better comprehension of the technical proposal of the present invention, an embodiment of the present invention is described in detail with the accompanying drawing herein.

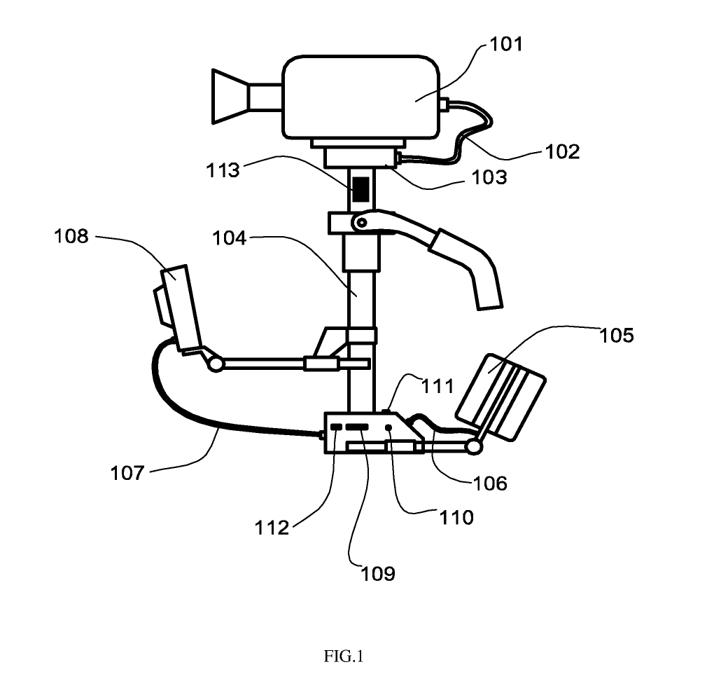

As illustrated in FIG. 1, the stabilizing rod for a video camera 104 comprises a data processing circuit 103. The data processing circuit 103 may be disposed at any position on the stabilizing rod. The video camera 101 (or a video camera unit formed by a lens and an image sensor unit), the monitor 108 and the battery 105 are components external to the stabilizing rod for a video camera stabilizer. They are connected to the data processing circuit 103 respectively. The battery 105 supplies electricity for the monitor 108 and the data processing circuit 103. The battery 105 supplies electricity to the data processing circuit via electric wire 106. The data output terminal of the video camera 101 outputs image signals, and connects via cable 102 to the data input terminal of the stabilizing rod 104 in order to transmit data signals to the data processing circuit 103 of the stabilizing rod 104. The data processing circuit 103 converts image signals to digital format signals. The monitor 108 receives signals transmitted from the data processing circuit 103 for monitoring the images. The stabilizing rod for a video camera stabilizer further comprises memory units 113. The memory units 113 are connected to the data processing circuit 103 for receiving digital format signals from the data processing circuit 103 and recording the digital format signals. The memory units 113 are disposed on the stabilizing rod 104 or other devices such as the video camera 101 or the monitor 108.

Furthermore, the stabilizing rod for a video camera stabilizer 104 further comprises plug-in slots 109 which is connected to the data processing circuit 103 for installing and removing expanded memory units. In this way, it is possible to record further digital format signals, and to replace other memory units by plugging into the plug-in slot 109 so as to continue recording digital format signals after the memory units are full. The memory units may be removable hard disks, SD cards, U-drives and so forth. The plug-in slots 109 are slots compatible with these memory units. The data processing unit 103 connects to the monitor 108 via cable 107. Browsing and editing various data in the memory units on the monitor 108 is attained by button operation.

Furthermore, the stabilizing rod for a video camera stabilizer 104 further comprises communicating ports 112 which is connected to the data processing circuit 103 for external signal communicating in digital format. It is then possible to playback or edit the currently filming images via an external device.

Furthermore, the stabilizing rod for a video camera stabilizer 104 further comprises buttons 111. The buttons 111 are connected to the data processing circuit 103, the memory units, the plug-in slots 109 and the communicating ports 112 respectively. There may be one or more than one buttons 111. The buttons 111 may be disposed on the stabilizing rod 104 or on the monitor 108 or the video camera 101. The buttons may be disposed together or separately. The buttons 111 transmits control signals to switch on or off the memory units, the plug-in slots 109 and the communicating ports 112.

Furthermore, the stabilizing rod for a video camera stabilizer 104 further comprises indicating lights 110. The indicating lights 110 are connected to the data processing circuit 103, the memory unit, the plug-in slots 109 and the communicating ports 112 respectively as well as to the buttons 111. There may be one or more than one indicating lights 110. The indicating lights 110 may be disposed on the stabilizing rod 104 or on the monitor 108 or the video camera 101. The indicating lights 110 may be disposed together or separately. The indicating lights 101 are used to indicate status of the data processing circuit 103, the memory units, the plug-in slots and the communicating ports.

The above is a detailed description of an embodiment of the stabilizing rod for a video camera stabilizer of the present invention. For a person skilled in the art, other embodiments and applications are possible according to the spirit of the present invention. Therefore, the present description should not be interpreted as limiting the present invention.

What is claimed is:

1. A stabilizing rod for a video camera stabilizer which comprises a data processing circuit, characterized in that it further comprises memory units which are connected to the data processing units for receiving digital format signals from the data processing units and recording the digital format signals.

2. The stabilizing rod for a video camera stabilizer as in claim 1, characterized in that the memory units are disposed on the stabilizing rod.

3. The stabilizing rod for a video camera stabilizer as in claim 1, characterized in that it further comprises plug-in slots which are connected to the data processing circuit for installing and removing expanded memory units.

4. The stabilizing rod for a video camera stabilizer as in claim 1, characterized in that it further comprises communicating ports which are connected to the data processing circuit for external signal communication in digital format.

5. The stabilizing rod for a video camera stabilizer as in claim 1, characterized in that it further comprises buttons which are connected to the data processing circuit, the memory units, the plug-in slots and the communicating ports respectively.

6. The stabilizing rod for a video camera stabilizer as in claim 5, characterized in that it further comprises indicating lights which are connected to the data processing circuit, the memory units, the plug-in slots and the communicating ports respectively as well as to the buttons for indicating status of the data processing circuit, the memory units, the plug-in slots and the communicating ports.
